(19) United States
(12) Patent Application Publication
(10) Pub. No.: US 2020/0127901 A1
(43) Pub. Date: Apr. 23, 2020

(54) SERVICE AWARE UPLINK QUALITY DEGRADATION DETECTION

(71) Applicant: VMWARE, INC., Palo Alto, CA (US)

(72) Inventors: Srikanth Hariharan, Sunnyvale, CA (US); Adnan Raja, Palo Alto, CA (US); Manu Sharma, Palo Alto, CA (US); Deepak Khurana, Palo Alto, CA (US); Alexandros Anemogiannis, Palo Alto, CA (US); Aditya Gudipati, Los Angeles, CA (US); Sarabjot Singh, Palo Alto, CA (US)

(21) Appl. No.: 16/718,631

(22) Filed: Dec. 18, 2019

Related U.S. Application Data
(60) Provisional application No. 62/781,339, filed on Dec. 18, 2018.
(60) Provisional application No. 62/728,356, filed on Sep. 7, 2018.

(51) Int. Cl. H04L 12/24; H04L 1/00; H04B 17/336; H04L 1/20; H04W 76/28; H04L 5/00; G06N 20/00

(52) U.S. Cl. CPC H04L 41/5009; H04L 1/0026; H04B 17/336; H04L 1/20; G06N 20/00; H04L 5/0055; H04L 41/0631; H04L 41/22; H04W 76/28

(57) ABSTRACT

A system can include a network analysis platform that applies models to identify uplink quality degradation at a network cell, such as at a base station. For a session at a cell, an expected user experience can be compared to an actual user experience to determine whether the session is impacted by poor uplink quality. The user experience metric can be either downlink throughput or uplink voice quality. The root cause for either can be determined to be uplink interference or uplink coverage. If the number of impacted sessions exceeds a threshold, the base station can be highlighted on a GUI. Additionally, the network analysis platform can perform root cause analysis of a victim cell.

### CROSS-REFERENCE TO RELATED APPLICATIONS

This non-provisional application claims priority to provisional application No. 62/781,339, titled “Service Aware Uplink Quality Degradation Detection,” filed Dec. 18, 2018, and also claims priority to provisional application No. 62/728,356, titled “Systems and Methods for Service Aware Uplink Quality Degradation Detection,” filed May 29, 2019, both of which are incorporated by reference in their entireties.

### BACKGROUND

In the context of telco networks, uplink quality can impact user experience in various ways. On the uplink, a user device can send control channel information and data channel information to a base station. These uplink communications require a minimum signal-to-interference-plus-noise (“SINR”) ratio with respect to both channels. Poor uplink quality can significantly degrade the user experience by causing insufficient uplink or downlink throughput, poor voice quality, call drops, and setup failures. Broadly speaking, uplink quality can encompass both uplink interference and uplink coverage.

Poor uplink SINR in the control channel can result in signaling failures leading to lost scheduling grants, lost hybrid automatic repeat request (“HARQ”) feedback for downlink transmissions, and lost downlink channel quality feedback. These issues can prevent a session from getting scheduled on the uplink in a timely manner. They can also cause retransmissions on the downlink and the use of incorrect modulation and coding schemes on the downlink. Poor uplink SINR in the data channel, on the other hand, can cause additional problems. For example, it can lead to low uplink throughput, excessive packet loss, lost HARQ feedback, and lost downlink channel quality feedback. These issues can affect both uplink and downlink services and can be caused by uplink interference or inadequate uplink coverage.

For example, in wireless networks, poor uplink SINR can be caused by radio frequency interference in the licensed wireless spectrum in which the wireless network operates. It can also be caused by poor uplink coverage. Radio frequency interference is often caused by external sources, such as unauthorized jammers, out-of-band emissions from devices, sources such as passive intermodulation (“PIM”), or inter-cell interference due to poor radio frequency (“RF”) planning. Poor uplink coverage can be due to high path loss between the user and the network. Since the available uplink power of a user device is typically limited, users can be power restricted beyond a certain path loss which degrades the quality of the signal received at the base station.

As a result, a need exists for detecting uplink quality degradation and identifying potential root causes responsible for the lowered uplink quality.

### SUMMARY

Examples described herein include systems and methods for detecting uplink quality degradation and root cause analysis (“RCA”) in a telco network. A network analysis platform can detect a session impacted by uplink quality degradation at a network cell, such as a base station. When a threshold number of impacted sessions at the cell exists, a graphical user interface (“GUI”) can display a related alert. To do this, the network analysis platform can use one or more performance models that are trained to determine an impacted session based on uplink quality. The performance model can be trained based on historical data. An actual user experience can be compared against an expected user experience based on normalized features that can be used as inputs to the performance model. The user experience itself can be represented by uplink throughput, downlink throughput, uplink voice quality, call drops, or setup failures, in an example. Telemetry data related to the user experience can be contained in a subscriber session record, in an example.

To detect a session impacted by uplink quality degradation, the network analysis platform can compare actual and expected user experience for a session at a first base station. In one example, the network analysis platform can determine an actual user experience value for a first session. This can include analyzing telemetry data for a cell to determine the current user experience. The telemetry data, such as in a subscriber session record, can be related to uplink throughput, downlink throughput, voice quality, call drops, or setup failures. Alternatively, a performance model can be used to output a user experience value for downlink throughput or uplink voice quality.

The network analysis platform can also predict an expected user experience value for the first session. This can be based on a normalized uplink quality with respect to the first base station, wherein the normalized uplink quality is based on uplink quality across the plurality of base stations. Uplink quality features can include uplink coverage, control and data channel SINR, uplink modulation and coding scheme, uplink negative-acknowledgment (“NACK”) and discontinuous transmission (“DTX”) rates, and downlink DTX rate. For example, downlink DTX rate can be adjusted to the 75th percentile of the downlink DTX rate for the given downlink channel quality index (“CQI”) of the session. If uplink control channel SINR is below a threshold, it can be normalized to the 75th percentile.

The performance model can output an expected user experience value for comparison with the actual user experience value. The network analysis platform can classify the first session as impacted by uplink quality degradation based on the expected user experience value exceeding the actual user experience value by at least a threshold amount. The user experience values can be uplink throughput, uplink voice quality, uplink interference, or uplink coverage in an example. In one example, multiple user experience values are compared to ensure the session is impacted by uplink quality degradation.

When a threshold number of sessions are impacted, the GUI can indicate that uplink quality degradation exists with respect to the first base station. For example, the GUI can show the first base station on a map and highlight the base station in a manner that indicates uplink quality degradation. In one example, the GUI indicates how many sessions are impacted by the uplink quality degradation at the base station. This can alert administrators to the issue. In one example, the alert can be generated in response to a service policy violation. The alert can include an aggregate number of uplink quality problems during a time period, wherein multiple alerts are ordered based on a number of impacted sessions.

The network analysis platform can also perform RCA on serving cells with uplink quality degradation. This can include determining if the issue is due to uplink interference. For impacted sessions, the network analysis platform can identify whether the SINR is low relative to uplink path loss. Alternatively, uplink interference can exist if the SINR is low along with the session not being significantly power restricted. The GUI can isolate sessions that are not power limited with respect to uplink power, in an example.

The examples summarized above can each be incorporated into a non-transitory, computer-readable medium having instructions that, when executed by a processor associated with a computing device, cause the processor to perform the stages described. Additionally, the example methods summarized above can each be implemented in a system including, for example, a memory storage and a computing device having a processor that executes instructions to carry out the stages described.

Both the foregoing general description and the following detailed description are exemplary and explanatory only and are not restrictive of the examples, as claimed.

### BRIEF DESCRIPTION OF THE DRAWINGS

FIG. 1 is a flowchart of an example method for detecting uplink degradation and performing root cause identification.

FIG. 2A is a sequence diagram of an example method for detecting uplink quality degradation.

FIG. 2B is a flowchart of an example method for detecting uplink quality degradation.

FIG. 3A is a flowchart of an example method for using performance models to determine uplink quality impact on a session.

FIG. 3B is an illustration of example system components for detecting uplink degradation and root cause identification.

FIGS. 4A and 4B are illustrations of an example GUI screen for alerts regarding uplink degradation.

FIGS. 5A and 5B are illustrations of an example GUI screen alerts regarding uplink degradation.

FIGS. 6A and 6B are illustrations of an example GUI screen for alerts regarding uplink degradation.

FIGS. 7A and 7B are illustrations of an example GUI screen for alerts regarding uplink degradation.

### DESCRIPTION OF THE EXAMPLES

Reference will now be made in detail to the present examples, including examples illustrated in the accompanying drawings. Wherever possible, the same reference numbers will be used throughout the drawings to refer to the same or like parts.

The system can include a network analysis platform that applies performance models to determine if uplink quality degradation exists at a cell, such as at a base station. This can be tested based on comparing actual and expected user experiences with respect to: (1) downlink throughput caused by uplink interference, (2) downlink throughput caused by uplink coverage, (3) uplink voice quality caused by uplink interference, and (4) uplink voice quality caused by uplink coverage. Therefore, the service aspects tested can include downlink throughput and uplink voice quality, and the uplink quality tested for those aspects can include uplink interference and uplink coverage.

The performance models are trained based on network telemetry data that is collected by the network analysis platform, such as from a subscriber session record. The training can occur offline to create a regression model that predicts downlink throughput based on inputs derived from the telemetry data. A classification model can be used for voice quality. The classification model can output a value indicating whether voice quality is good or bad.

For a session at a cell, an expected user experience can be compared to an actual user experience to determine whether the session is impacted by coverage degradation. The user experience can be based on downlink throughput or uplink voice quality, in an example. To determine the expected user experience based on downlink throughput, downlink DTX rate can be changed to a normalized value based on the CQI of the cell. The performance model can then output an expected downlink throughput value that the network analysis platform can compare to actual downlink throughput. If the improvement in downlink throughput is greater than a threshold, such as 10% or 20%, then the user session can be classified as impacted by uplink quality. In addition, if the session is not power limited in the uplink (e.g., less than 50% of the time), then the root cause can be determined as uplink interference. To determine the expected user experience based on uplink voice quality, the control channel SINR or data channel SINR can be normalized and the classification model can output a voice quality value that is compared to the actual voice quality value.

A GUI can display the cells and number of corresponding sessions impacted by a cell's uplink quality degradation. When the number of impacted sessions exceeds a threshold, RCA can also be performed so that an administrator or an automated process can take corrective action. For example, by analyzing incoming and outgoing handoffs at a victim cell, the GUI can display a root cause. The root cause can be, for example, vendor load balancing parameters or a coverage footprint of the base station.

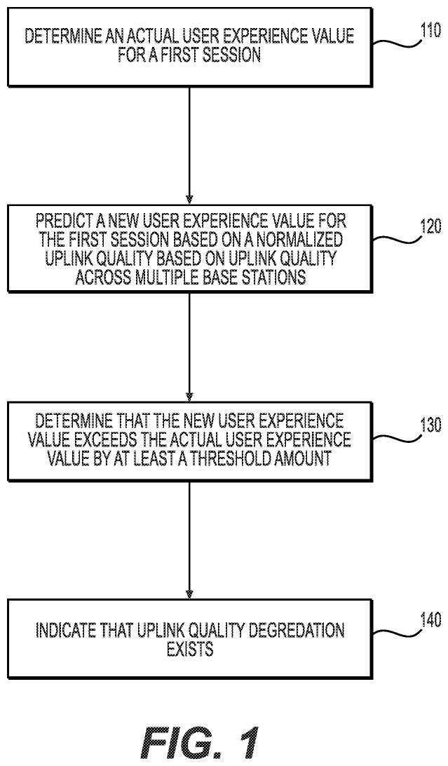

FIG. 1 is a flowchart of an example method for detecting uplink quality degradation and performing root cause identification. At stage 110, the network analysis platform can determine an actual user experience value for a first session. The user experience value can be determined for either downlink throughput or uplink voice quality.

The downlink throughput can be measured for the session based on telemetry data collected at the base station, in an example. For example, cells in the network can send telemetry data to the network analysis platform. Example cells can include base stations, cell towers, or any node within the network. In one example, the network analysis platform can determine actual downlink throughput by applying a performance model to the telemetry data. The performance model can be pre-trained to output downlink throughput based on other factors. The factors can include signal quality, cell load, and interference level. The training can include applying machine learning algorithms to a large set of telemetry data to tune a performance model for predicting downlink throughput.

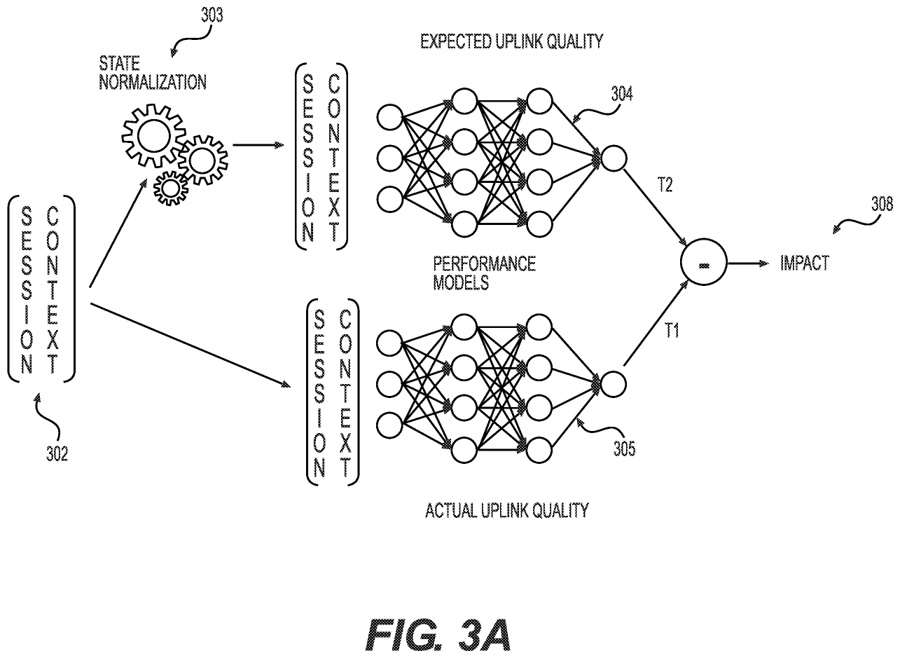

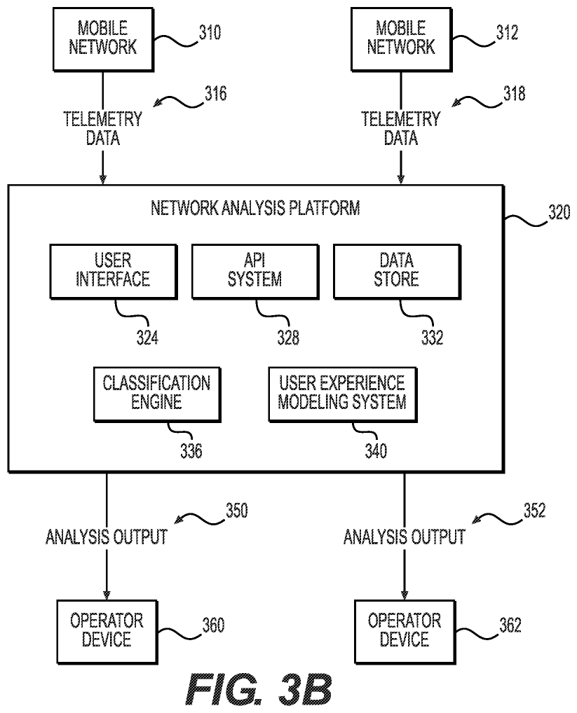

The telemetry data can include key performance indicators (“KPIs”), such as round-trip time for data packets, latency, and other indicators that can be used to determine throughput. The telemetry data can also include user network session throughput information for at least one user network session and user network session radio access network (“RAN”) information for at least one user network session. This information will also be described in more detail with respect to FIG. 3B.

At stage 120, the network analysis platform can predict an expected user experience value for the first session based on a normalized uplink quality. The normalization can be based on the value of the uplink quality across like-type cells in the network. The uplink quality can be at least one of uplink interference and uplink coverage. In one example, the uplink quality is normalized to a value that reflects a percentile of the first session's path loss relative to signal quality of other sessions at the first base station. The uplink quality can be normalized to a percentile of DTX rates across the network. The uplink quality can also be normalized to a CQI over the network. The normalized uplink quality can also include a percentile of control channel signal to noise ratio over the network and a percentile of data channel signal-to-noise ratio over the network.

Four examples of predicting expected user experience are discussed below. Those different user experiences are: (1) downlink throughput caused by uplink interference, (2) downlink throughput caused by uplink coverage, (3) uplink voice quality caused by uplink interference, and (4) uplink voice quality caused by uplink coverage.

Beginning with the first example, to determine the expected user experience based on downlink throughput caused by uplink interference, downlink DTX rate can be changed to a normalized value representing the 75^{th} percentile for like-type cells in the network. This can be done based on CQI for the cell. The CQI can have a value between 1 and 15. Given the CQI of the session, the DTX rate value for the 75^{th} percentile can be used. The performance model can then output an expected downlink throughput value that the network analysis platform can compare to actual downlink throughput in stage 130. If the improvement in downlink throughput is greater than a threshold, such as 10% or 20%, then the user session can be classified as impacted by uplink quality. In addition, if the session is not power limited in the uplink (e.g., less than 50% of the time), then the root cause can be determined as uplink interference.

Turning to the second example, user experience can also be predicted in terms of downlink throughput based on normalizing factors related to uplink coverage. Table 1 includes example normalized features for predicting an expected user experience based on downlink throughput due to uplink coverage.

TABLE 1
Example normalized features for downlink throughput based
on uplink coverage.

| Feature | Description |
|---|---|
| Path Loss_{New} | Q^{th} percentile of path loss over the network, where Q is |
| (normalized) | the percentile of the session's path loss in its serving cell. |
| CQI_{New} | C^{th} percentile of CQI over the network for the Path |
| (normalized) | Loss_{New} , where C is the percentile of the session's |
| | average CQI for its path loss. |
| NACK rate | 75^{th} percentile of NACK rate corresponding to the |
| (normalized) | CQI_{New} over the network if CQI_{New} is greater than the |
| | session's average CQI, otherwise no change to the |
| | NACK rate. |
| CQI2 | CQI2 + CQI_{New} minus the sesssion's average CQI if |
| (normalized) | CQI2 is greater than 0, otherwise 0. |

As shown above, the new path loss can be determined for the session as the path loss for the Q^{th} percentile of path loss over all users in the network. Q can be the percentile of the path loss for the session in the serving cell. Path loss is generally a function of distance and frequency. For example, if a user's path loss is at the median for all sessions in a cell, Q can be set to 50%.

Similarly, the new CQI can be determined for the session as the C^{th} percentile of CQI over all sessions in the network for the Path Loss_{New}, where C is the percentile of the session's average CQI for its path loss in the serving cell. Cells can transmit at higher and lower power, be macro or micro, and the cells used to determine the new CQI can be of similar cell type to the serving cell. In this way the percentile of the serving cell is preserved.

The normalized NACK rate can be based on NACK rates measured from telemetry data. It can be set at 75^{th} percentile, in an example, if the new CQI is greater than the original CQI. Otherwise, the NACK rate of the serving cell can be used. The second CQI (CQI2) is a ratio for a RANK2 transmission, since a cell often can transmit in multiple modes. The New CQI2 can be boosted based on a higher average CQI. These four features can be used as inputs to the performance model at stage 130.

In a third example, the network analysis platform can predict expected user experience based on uplink voice quality. To do so, the control channel SINR can be normalized to a value reflecting a percentile of the SINR across the network. For example, when the control channel (PUCCH) SINR is below zero, it can be normalized to a value reflecting the 75th percentile of control channel SINR over all user sessions in the network. When the SINR is below 0 decibels, this can indicate that the signal is lower than the levels of interference and noise.

Likewise, the data channel (PUSCH) SINR and the uplink NACK can both be normalized to respective values reflecting the 75^{th} percentile of cells in the network for the path loss and power restriction that are reported for the user session. The power restriction can be a value reflecting how often the user was power restricted, such as the number of time slots the user was power restricted in a given session. In one example, this normalization is contingent on the actual PUSCH SINR being low, such as below negative two decibels.

Table 2 includes example normalized features that can be used with the performance model for an expected user experience based on uplink voice quality.

TABLE 2
Example normalized features for voice quality
based on uplink interference.

| Normalized Feature | Description |
|---|---|
| PUCCH_SINR_{new} | When PUCCH SINR is below zero dB, normalize |
| | to the 75^{th} percentile of PUCCH SINR over the |
| | network. |
| PUSCH_SINR_{new} | When PUSCH SINR is below −2 dB, normalize to |
| | the 75^{th} percentile of PUCCH SINR over the |
| | network, for the user's given path loss and power |
| | restriction. |

The new SINR values can be used with the classification model for voice quality to output a user experience value. At stage 130, if the expected user experience value differs more than a threshold with the actual user experience value, this can indicate a significant change in probability that the session has voice quality degradation. As a result, the network analysis platform can conclude that the session is impacted by uplink interference.

In the fourth example, the user experience can be predicted based on uplink voice quality caused by uplink coverage. When coverage problems occur, typically many user sessions in a cell are impacted. For example, users in a building may receive poor connectivity compared to users at other cells in the network.

A normalized path loss can be calculated and used as an input to the classification model. If path loss is too high in the user's session, this can indicate inadequate coverage (e.g., the signal is too weak). The path loss can be normalized based on the percentile path loss for the session in the cell relative to the rest of the network. If the 90^{th} percentile path loss for the network is lower than the 90th percentile path loss for the cell, then the path loss is moved to the 90th percentile. As an example, if a cell causes a user to experience a path loss of 130 decibels (“dB”) but the network has a 90th percentile of 120 dB, then the path loss can be normalized to 120 dB.

Based on the new path loss value, uplink PUSCH SINR and percentage of uplink power restricted are also normalized, in an example. Each is changed corresponding to the new path loss. All three new features can be inputs to the model. A summary of these features is below in Table 3.

TABLE 3
Example normalized features for voice quality
based on uplink interference.

| Feature | Description |
|---|---|
| Path Loss_{New} | Q^{th} percentile of path loss over the network, where |
| (Normalized) | Q is the percentile of the session's path loss |
| | in its serving cell. |
| PUSCH_SINR_{New} | When PUSCH SINR is below −2 dB, normalize |
| (Normalized) | to the C^{th} percentile of PUSCH SINR over the |
| | network for Path Loss_{New.} |
| Percentage of | normalize to the C^{th} percentile of uplink power |
| Uplink Power | restricted over the network for Path Loss_{New.} |
| Restricted_{New} | |
| (Normalized) | |

These normalized values can be used with the classification model for voice quality to output a user experience value. At stage 130, if the expected voice quality probability reduces by a threshold amount, this can mean that the session voice quality was impacted by uplink coverage.

At stage 130, the network analysis platform can classify the first session as impacted by uplink quality degradation based on the expected user experience value differing from the actual user experience value by at least a threshold amount. This can be based on any one or combination of the four different user experience values described above: (1) downlink throughput caused by uplink interference, (2) downlink throughput caused by uplink coverage, (3) uplink voice quality caused by uplink interference, and (4) uplink voice quality caused by uplink coverage. The threshold amount can be different for each of the four different user experience value types. An administrator can set the thresholds in one example in order to tune the sensitivity of alerts regarding uplink quality degradation.

The output of a performance model for downlink throughput can differ from the model for voice quality. The model for uplink voice quality can output a voice quality value that indicates a likelihood of voice quality degradation in the session. For example, the value can be between zero and one, with zero representing likely total degradation and one being likely near perfect voice clarity. If the comparison between actual and expected voice quality reveals a threshold change between the outputs, such as 10%, then the network analysis platform can classify the session as impacted by uplink quality degradation.

At stage 140, when a threshold number of sessions are impacted, a GUI can indicate that uplink quality degradation exists with respect to the first base station. In one example, the GUI represents cells in the network, including the first base station. These cells can be represented on a map relative to their geographic locations. The first base station can be highlighted on the map when a threshold number of session impacts are detected for the first base station. For example, the network analysis platform can count each session that is impacted in stage 130 and display the number of impacted sessions, in an example. If the number of impacted sessions exceeds a threshold, then the GUI can draw the administrator's attention based on additional highlighting of the base station icon or number of impacted sessions.

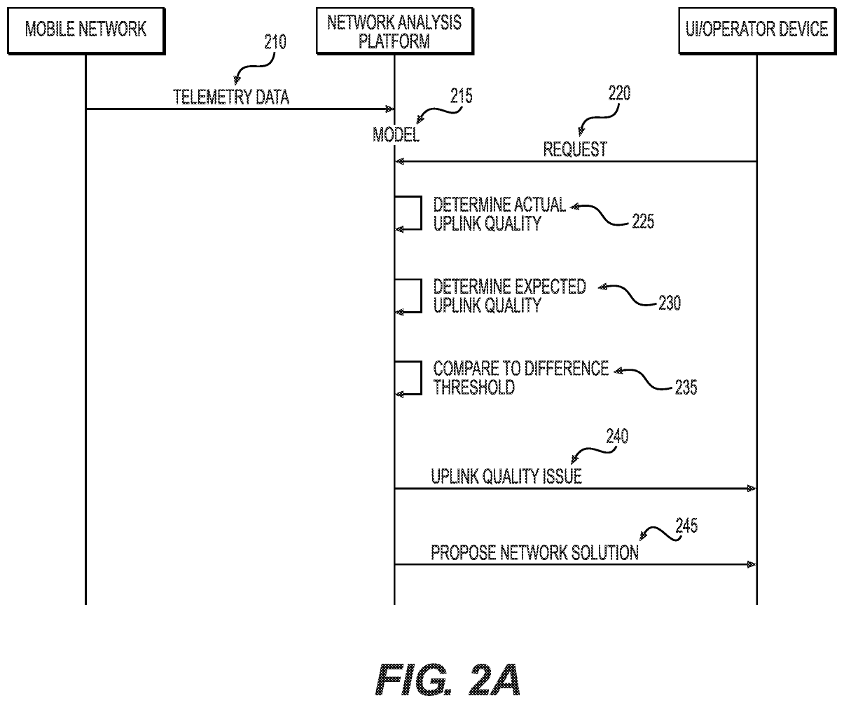

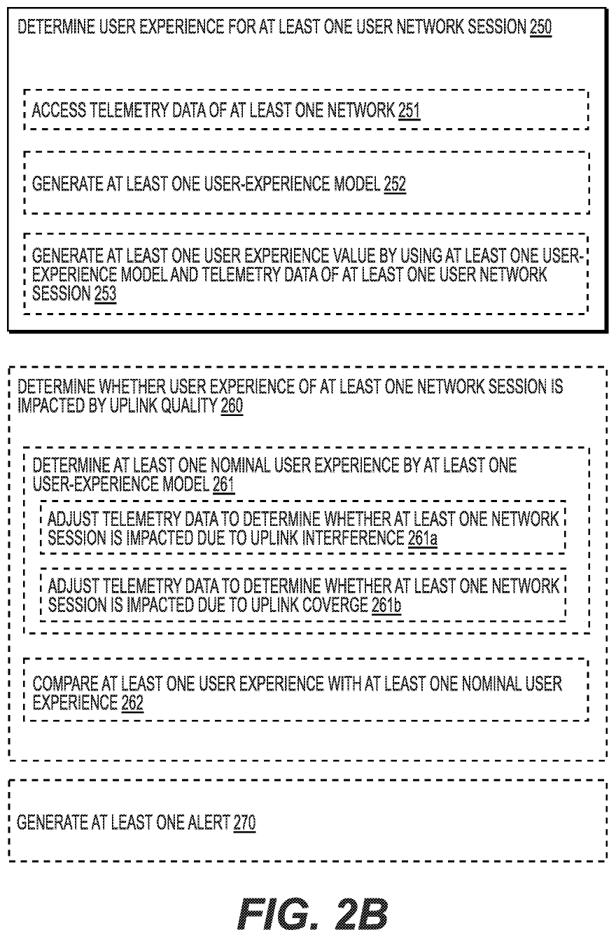

FIG. 2A is a sequence diagram of an example method for detecting uplink quality degradation and root cause identification. At stage 210, telemetry data can be received at the network analysis platform from various cells within the mobile network. Stage 210 can be ongoing in an example, with telemetry data being received at periodic intervals or constantly queued from reporting cells. The telemetry data can be captured and measured in real time by base stations, which send the telemetry data to the network analysis platform.

At an operator device, an administrator can use a GUI to request cell performance information at stage 220 that relates to user experience on the network. This can include requesting information about uplink quality on the network, such as by providing a selection option to check for uplink quality degradation within the network. In another example, the request is a query that can identify either a user, a set of users, or a time range. The user can correspond to a particular session ID. The time frame query can instead look for problems for all or multiple sessions within the time frame.

In another example, stage 220 is an automated request. The GUI or operator device can request updated analytics for the cells in the network. This can include requesting uplink quality information at stage 220. Other requests can be made for other metrics or potential problem sources that can also be displayed on the GUI, such as load imbalances.

At stage 225, the network analysis platform can determine an actual user experience value related to an uplink quality, such as uplink interference or uplink coverage. This can be done for either downlink throughput or uplink voice quality. The model for downlink throughput can differ from that of uplink voice quality. The models can output one or more actual user experience values.

At stage 230, the expected user experience can be predicted by using the model with normalized uplink quality values. Example normalized values are described above with regard to stage 130 of FIG. 1, including Tables 1-3. The normalized values can relate to either uplink interference or uplink coverage. The expected user experience can be predicted based on either downlink throughput or uplink voice quality. The model for downlink throughput can differ from that of uplink voice quality. The models can output one or more expected user experience values.

At stage 235, the network analysis platform can compare the actual and expected user experience values to determine if the session suffers from uplink quality degradation. This can be done for some or all of the four different user experiences described above: (1) downlink throughput caused by uplink interference, (2) downlink throughput caused by uplink coverage, (3) uplink voice quality caused by uplink interference, and (4) uplink voice quality caused by uplink coverage. Each can have a different threshold that indicates an impact. These different analyses also indicate different root causes between uplink interference or uplink coverage.

At stage 240, the GUI can display the uplink quality issues determined at the network analysis platform. For example, the GUI can identify the base station causing the uplink quality impacts on the sessions. In one example, the GUI can highlight the base station when a threshold number of sessions are impacted based on stage 250. That threshold can depend on the request of stage 220. For example, if the request is for a limited number of sessions, then the threshold can be as low as one session. But otherwise it could be some larger number of sessions to ensure only the more problematic base stations are highlighted.

At stage 245, the GUI can also present the root cause and propose a network solution. For example, the uplink quality degradation can be due to uplink interference or poor uplink coverage. The administrator can attempt to determine the interference source, in an example. The administrator can also adjust signal strength or tilt angle of the base station, in an example.

FIG. 2B is an illustration of an example method for identifying sessions impacted by uplink quality degradation. Stage 250 can include determining user experience for at least one user network session. In some examples, the method is performed by a network analysis platform. The method can also include, at stage 260, determining whether user experience of at least one network session is impacted by uplink quality and, at stage 270, generating at least one alert.

In some embodiments, stage 250 includes at least one of: accessing telemetry data of at least one network at stage 251; generating at least one user-experience model at stage 252; and generating at least one user experience value by using at least one user-experience model and telemetry data of at least one user network session at stage 253. Stage 251 can include: accessing telemetry data of at least one network from at least one of a network node and a data store as described herein. Stage 251 can include accessing telemetry data of a plurality of networks. In an example, stage 251 includes accessing RAN information for a user network session.

Stage 252 can include generating at least one user-experience model as described herein with respect to the description of the user experience modeling system. In some examples, stage 252 includes generating at least one user-experience model for at least one platform account of the platform.

Stage 253 can include generating a plurality of user experience values for a plurality of user network sessions. Stage 253 can also include generating an actual user experience value for actual RAN information of a user network session by inputting the actual RAN information into a user-experience model (e.g., generated by the user experience modeling system 131) for the platform account associated with the user network session.

Stage 260 can include at least one of: determining at least one nominal user experience by using at least one user-experience model at stage 261; and comparing at least one actual user experience with at least one nominal user experience at stage 262.

Stage 261 can include: generating nominal RAN information by adjusting feature values of the RAN information (of the user network session being evaluated) that relate to uplink quality. In some embodiments, the feature values of the RAN are adjusted so that the adjusted feature values correspond to a nominal uplink quality value for a location associated with the user network session and for cell characteristics (e.g., bandwidth, available control channel elements, etc.) associated with the user network session. In some embodiments, the adjusted feature values include values of uplink quality features. In some embodiments, uplink quality features include uplink coverage, control channel SINR, data channel SINR, uplink modulation and coding scheme, uplink NACK rate, uplink DTX rate, and downlink DTX rate.

Stage 261 can include stage 261a. Stage 261a can function to adjust telemetry data to determine whether at least one network session is impacted due to uplink interference. 261a can function to determine whether a user session that is not significantly power restricted is being impacted by uplink interference. Stage 261 can also include stage 261b. Stage 261b can function to adjust telemetry data to determine whether at least one network session is impacted due to uplink coverage.

In one example, in a case wherein downlink throughput is the user experience metric being evaluated, adjusting telemetry data (e.g., adjusting feature values) at stage 261a (determining whether downlink throughput is impacted by uplink interference) includes: adjusting downlink DTX rate to the 75th percentile of the downlink DTX rate for the downlink CQI associated with the user network session (as identified by the accessed telemetry data). In some embodiments, uplink interference sessions are isolated by identifying sessions that are impacted but were not power limited in the uplink.

When downlink throughput is the user experience metric being evaluated, adjusting telemetry data (e.g., adjusting feature values) at stage 261b (determining whether downlink throughput is impacted by uplink coverage) can include adjusting feature values as follows: New path loss=Qth percentile of path loss over the network, where q is the percentile of session's original path loss in its serving cell; New average CQI=Cth percentile of CQI over the network for the new path loss, where C is the percentile of session's original average CQI for its original path loss; New DL (down link) NACK rate=75th percentile of DL NACK rate for that average CQI bin over the network if new average CQI>original average CQI, else no change; New CQI2 ratio=Original CQI2 ratio+(New average CQI−original average CQI) if Original CQI2 ratio>0, else 0.

When uplink voice quality is the user experience metric being evaluated, adjusting telemetry data (e.g., adjusting feature values) at stage 261a (determining whether downlink throughput is impacted by uplink interference) can include: adjusting feature values as follows: (a) adjusting the physical uplink control channel (PUCCH) SINR feature value (below zero) to the 75th percentile of PUCCH SINR values (below zero) observed within the network; and (b) adjusting the physical uplink shared channel (PUSCH) SINR feature value (below −2) to the 75^{th} percentile of PUSCH SINR feature values (below −2) observed within the network for the given user's path loss and power restriction, and uplink transmission frequency.

When uplink voice quality is the user experience metric being evaluated, adjusting telemetry data (e.g., adjusting feature values) at stage 261b (determining whether downlink throughput is impacted by uplink coverage) can include adjusting feature values as follows: (a) New path loss=Qth percentile of path loss over the network, where q is the percentile of session's original path loss in its serving cell; (b) New PUSCH SINR=Cth percentile of PUSCH SINR over the network for the new path loss, and Band where c is the percentile of session's PUSCH SINR for its original path loss; (c) New power restriction=Cth percentile of power restriction over the network for the new path loss, where c is the percentile of session's original PUSCH SINR for its original path loss.

Stage 261 can include: determining at least one nominal user experience value by inputting the nominal RAN information into the user-experience model (e.g., generated by the user experience modeling system 131) for the platform account associated with the user network session being evaluated (e.g., the model used at 253).

Stage 262 can include comparing an actual user experience value generated for a user network session (e.g., at 250) with the corresponding nominal user experience value generated at 261. Stage 262 can include determining a difference between the actual user experience value generated for a user network session with the corresponding nominal user experience value generated at stage 261, and comparing the difference to a threshold value; responsive to a determination that the difference exceeds the threshold value, the platform determines that the user experience of the user network session being evaluated is impacted by uplink quality caused by uplink interference or uplink coverage. In a case where the nominal user experience value is generated by adjusting the telemetry data at stage 261a, the user experience is determined to be impacted by uplink interference. In a case where the nominal user experience value is generated by adjusting the telemetry data at stage 261b, the user experience is determined to be impacted by uplink coverage.

Adjusting feature values can include adjusting at least one user network session based on user-input provided by an operator device. In a first variation, the operator device can provide user input that specifies at least one adjusted feature value. In a second variation, the operator device can provide user input that specifies information used by the platform to adjust at least one feature value.

Stage 270 can include generating a service policy violation alert by aggregating uplink quality problems caused by uplink interference or uplink coverage across cells and time and ordering alerts by the number of impacted users (e.g., mobile network subscribers).

Stage 270 can include: generating a service policy violation alert for a network if the number of user network sessions identified by the platform as having uplink quality problems exceeds an alert threshold value. In some embodiments, stage 270 includes: generating a service policy violation alert for a network if the number of user network sessions identified by the platform as having uplink quality problems due to uplink interference exceeds an alert threshold value.

In some embodiments, stage 270 includes: grouping user network sessions identified by the platform as having uplink quality problems according to at least one of cell and time, and for each group, generating a service policy violation alert for a group if the number of user network sessions included in the group exceeds an alert threshold value.

In some embodiments, stage 270 includes providing at least one generated policy violation alert to an operator device.

In some embodiments, the method includes the platform providing to at least one operator device information that identifies whether uplink quality is caused by uplink radio frequency interference. In some embodiments, the method includes detecting uplink quality problems for user network sessions in a mobile network maintained by an operator. In some embodiments, the method includes determining one or more root causes for identified uplink quality problems and determining a prioritization of the uplink quality problems with respect to service degradation of a (e.g., mobile network subscriber). In some embodiments, the method includes providing to an operator device information indicating a root cause for uplink quality problems for at least one user network session. In some embodiments, the method includes providing the information to an operator device via at least one of the API system and the user interface system. Examples of the output include a user interface dashboard. The platform can optionally recommend one or more corrective actions for mitigating the uplink quality problems as part of the information provided to the operator device.

FIG. 3A is a flowchart of an example method for using performance or classification models to determine coverage degradation impact. The models 304, 305 can be used to determine an expected user experience for uplink quality and a current user experience relative to a session, in an example. The process can start using session context 302, which can include various parameters regarding the session, such as signal quality, path loss, CQI, and NACK rate.

At stage 303, normalization can occur so that certain feature values are set to a normalized level for determining expected user experience. The normalized features relate to uplink quality and are referred to in FIG. 1, stage 130. These normalized feature values can be used as inputs, along with other session context, in the model 304. The model 304 can output an expected user experience value T2. Depending on whether downlink throughput or uplink voice quality is being measured as the user experience, the output can be throughput or a predicted quality level, respectively. Other outputs for T2 are also possible.

This expected user experience value (T2) can be compared against an actual user experience at the cell during the session. The actual user experience can likewise be estimated by the model 305, which can be the same as model 304 in an example. The output of actual user experience can be T1.

The difference between T2 and T1 can indicate an impact 308, in an example. In one example, the difference between T2 and T1 must exceed a threshold before an impact 308 is indicated. The network analysis platform can track the number of impacts at a cell for purposes of identifying victim cells and displaying impact numbers on the GUI.

FIG. 3B shows an illustration of an example system that includes a network analysis platform 320 and a network 310. The network 310 can be a wireless network that provides network communication for mobile devices. For example, the network 310 can be at least one of a mobile network, cellular network, wireless network, wireless spectrum network, or any other network maintained by a network operator. In some examples, the network operator is a streaming media provider, internet service provider, vendor, or other entity associated with a network.

The mobile network 310 can send telemetry data 316 to the network analysis platform 320. The network analysis platform 320 can also receive information from a separate, second mobile network 312 that provides its own telemetry data 318. The telemetry data 316, 318 can provide a time-frequency characteristic and a spatial characteristic. In some examples, telemetry data 316, 318 includes at least one of: a timestamp of when an event occurred in the network 310, 312; a threshold relating to data bandwidth, download speed, call failure, or other aspect of the network has been exceeded, and at what time; the frequency of calls being dropped for VoiceIP data; the location of cell towers within the mobile network; customer complaints received, in which areas, and at what frequency; and any other data relating to the network 310, 312 and telemetry 316, 318. The platform 320 can monitor the network 310, 312 and collect the associated telemetry data 316, 318. In some embodiments, the telemetry data 316, 318 is stored within a datastore 332 within the platform 320 or available to the platform 320.

The telemetry data 316, 318 can also include at least one of user network session throughput information for at least one user network session, and user network session radio access network (RAN) information for at least one user network session. In some examples, RAN information includes information describing radio communication between a transceiver of an edge node of the network 310, 312 and a modem of a UE of the user network session. In some embodiments, RAN information for a user network session (“user session” or “session”) includes at least one of: downlink coverage (RSRP, RSRQ) of the user session; downlink quality (SINR, CQI) experienced by the user session; uplink coverage (path loss, uplink power restriction) of the user session; uplink quality (PUSCH, PUCCH SINR) experienced by the user session; downlink modulation and coding for the user session; uplink modulation and coding for the user session; downlink physical resource block (“PRB”) resources allocated for the user session; downlink PRB usage of cell; uplink PRB resources allocated for the user session; uplink PRB usage of cell; control channel utilization in cell; number of active users in cell on uplink and downlink; number of active users in cell perceived by user session; QCI of the user session; downlink NACK rate of the user session; downlink DTX rate of the user session; uplink NACK rate of the user session; uplink DTX rate of the user session; available bandwidth and control channel elements on uplink and downlink; and Power Headroom Reports (“PHR”) of the user session.

In some examples, the network 310, 312 includes at least one infrastructure element, such as, for example, a base station, a cell tower, and other elements of a mobile network infrastructure. The network 310, 312 can be a Long-Term Evolution (“LTE”) network or a 5G network, for example. In some embodiments, the network 310, 312 includes at least one edge node. The edge node can include at least one of a radio transceiver, a power amplifier, and an antenna. In some examples, the edge node is constructed to exchange information with at least one user device (e.g., a mobile phone or IoT device that includes a wireless network interface device) using the radio transceiver of the edge node and a radio transceiver included in a wireless modem of the user device.

In some examples, the edge node of the network 310, 312 is a base station node. For example, the edge node can be an Evolved Node B (“eNodeB”). The edge station node can be communicatively coupled to at least one of a Radio Network Controller (“RNC”), a Mobility Management Entity (“MME”) node, a gateway node (such as a serving gateway or packet data network gateway), and a home subscriber server (“HSS”).

In some examples, prior to exchanging information with a user device, the edge node establishes a wireless communication session with the user device by performing a signaling process, the result of the signaling processing being an established communication session between the user device and the edge node of the network 310, 312. In some examples, each session between a user device and an edge node of the network is managed by an MME of the network 310, 312.

The network analysis platform 320 can be implemented by a mobile networking service, network monitoring and/or control service, network security service, internet service provider, or any other network service. In some examples, one or more aspects of the system can be enabled by a web-based software platform operable on a web server or distributed computing system. In some examples, the platform 320 can be implemented as at least one hardware device that includes a bus that interfaces with processors, a main memory, a processor-readable storage medium, and a network interface device. The bus can also interface with at least one of a display device and a user input device.

In some examples, at least one network interface device of the platform 320 is communicatively coupled to at least one network interface device of the network 310, 312 (e.g., an MME) directly or indirectly via one of a public network (e.g., the Internet) or a private network. In some examples, at least one network interface device of the platform 320 is communicatively coupled to a network interface device of at least one operator device 360, 362.

The platform 320 can include an API system 328 that provides an API that is used by a device (e.g., operator device 360, 362, a network monitoring system of the network 310, 312, a node of the network 310, 312) to communicate with the platform 320. In some examples, the API system 328 provides a REST API. The API system 328 can include a web server that provides a web-based API. The API system 328 can be configured to process requests received from a node of the mobile network 310, 312 (e.g., a network monitoring system) to receive telemetry data from the network 310, 312. In some embodiments, the API system 328 includes a web server that provides a web-based API.

In some examples, the platform 320 includes a user interface system 324. The user interface system 324 can be an application server (e.g., web server) that is configured to provide a user interface through which an operator device 360, 362 can interact with the platform 320. The platform 320 can process requests received from an operator device 360, 362 (e.g., through the API system 328 of the platform 320 or the user interface system 324 of the platform 320) relating to telemetry data 316, 318 from the network 310, 312. For example, the operator device 360, 362 can provide the platform 320 with connection information for establishing a network connection with a node of the mobile network 310, 312, and the platform 320 can use that connection information to establish a network connection with the node of the mobile network 310, 312 and receive telemetry data 316, 318 from the network 310 via the established network connection.

As mentioned above, the platform 320 can include a data store 322. The data store 322 can be a database (e.g., a relational database, a NoSQL database, a data lake, a graph database). The data store 322 include telemetry data of the network 310. The platform 320 can access telemetry data 316, 318 from the network 310, 312 and store the accessed telemetry data 316, 318 in the data store 332. The data store 332 can include one or more databases in which telemetry data 316, 318 collected from operators of mobile networks or other various entities is stored. In one example, the data store 332 includes a mobile network databank for storing mobile network data during an analysis of problems within the network.

The platform 320 can also include a user experience modeling system 340. In some examples, the modeling system 340 generates a trained user experience model that outputs a prediction of a user experience value given an input data set that includes data for one or more features included in RAN information of the network 310, 312. The data can include, for example, RAN information stored in the data store 332 and RAN information received as telemetry data 316, 318 from the network 310, 312. In some examples, each input data set input into the trained user experience model represents a user network session. For each input data set being used to train a user-experience model, the platform 320 can access information indicating at least one of uplink throughput, downlink throughput, voice quality, call drops, and setup failures. In some examples, for each input data set being used to train a user-experience model, the platform 320 stores information indicating at least one of uplink throughput, downlink throughput, voice quality, call drops, and setup failures.

In some examples, the modeling system 340 generates the trained user experience model to predict at least one of uplink throughput, downlink throughput, voice quality, call drops, and setup failures as a target of the model. The modeling system 340 can generate the trained user experience model based on user input received from the operator device 360, 362. The user input can identify at least one of a target for the model and a feature of RAN information to be used by the model. The platform 320 can store at least one trained user-experience model, such as by storing it within the data store 332. The platform 320 can also receive or access a trained user-experience model provided by an operator device 360, 362.

The platform 320 can be a multi-tenant platform that manages platform accounts for a plurality of networks 310, 312. For example, a first platform account can be associated with a first operator device 360 and first network 310, while a second platform account can be associated with a second operator device 362 and a second mobile network 312. In some examples, the platform 320 stores a first user-experience model for the first platform account and a second user-experience model for the second platform account. The first user-experience model can be trained on RAN information received from the first network 310, while the second user-experience model can be trained on RAN information received from the second network 312. Alternatively, the user-experience models can be trained based on combined information from both the first and second networks 310, 312. In some examples, the first user-experience model has a target selected by the first operator device 360, while the second user-experience model has a target selected by the second operator device 362.

The user experience modeling system 340 can include one or more of a local machine learning system (e.g., implemented in Python, R, or another language), a cloud-based machine learning client (e.g., an application communicatively coupled to a cloud-based machine learning system such as, for example, MICROSOFT AZURE MACHINE LEARNING SERVICE). At least one machine learning system included in the system 340 can be configured to perform one or more of: supervised learning (e.g., using logistic regression, back propagation neural networks, random forests, or decision trees), unsupervised learning (e.g., using an apriori algorithm or kmeans clustering), semi-supervised learning, reinforcement learning (e.g., using a Q-learning algorithm or temporal difference learning), and any other suitable learning style.

In some examples, at least one model generated by the system 340 implements at least one of: a regression algorithm (e.g., ordinary least squares, logistic regression, stepwise regression, multivariate adaptive regression splines, or locally estimated scatterplot smoothing), an instance-based method (e.g., k-nearest neighbor, learning vector quantization, or self-organizing map), a regularization method (e.g., ridge regression, least absolute shrinkage and selection operator, or elastic net), a decision tree learning method (e.g., classification and regression tree, iterative dichotomiser 3, C4.5, chi-squared automatic interaction detection, decision stump, random forest, multivariate adaptive regression splines, or gradient boosting machines), a Bayesian method (e.g., naïve Bayes, averaged one-dependence estimators, or Bayesian belief network), a kernel method (e.g., a support vector machine, a radial basis function, or a linear discriminant analysis), a clustering method (e.g., k-means clustering or expectation maximization), an associated rule learning algorithm (e.g., an apriori algorithm or an Eclat algorithm), an artificial neural network model (e.g., a Perceptron method, a back-propagation method, a Hopfield network method, a self-organizing map method, or a learning vector quantization method), a deep learning algorithm (e.g., a restricted Boltzmann machine, a deep belief network method, a convolutional network method, or a stacked auto-encoder method), a dimensionality reduction method (e.g., principal component analysis, partial least squares regression, Sammon mapping, multidimensional scaling, or projection pursuit), an ensemble method (e.g., boosting, bootstrapped aggregation, AdaBoost, stacked generalization, gradient boosting machine method, or random forest method), and any other suitable form of machine learning algorithm. In some examples, at least one processing portion of the system 340 can additionally or alternatively leverage: a probabilistic module, heuristic module, deterministic module, or any other suitable module leveraging any other suitable computation method, machine learning method or combination thereof. Any suitable machine learning approach can otherwise be incorporated in the system 340.

In some examples, the platform 320 can identify whether a user network session (e.g., a wireless communication session between a user device and an edge node of a wireless network) that is not achieving a desired QoS (Quality of Service) is impacted by an uplink quality problem, and provide information that identifies whether uplink quality is caused by uplink radio frequency interference or uplink coverage limitations. In some embodiments, the network analysis platform 320 functions to detect uplink quality problems for user network sessions in a mobile network maintained by an operator. In some embodiments, the platform 320 is constructed to determine one or more root causes for identified uplink quality problems and determine a prioritization of the uplink quality problems with respect to service degradation of a (e.g., mobile network subscriber). In some embodiments, the platform 320 is constructed to provide to an operator device information indicating a root cause for uplink quality problems for at least one user network session. In some embodiments, the platform 320 provides the information to an operator device via at least one of the API system and the user interface system. Examples of the output include a user interface dashboard (e.g., as shown in FIG. 3). The platform 320 optionally recommends one or more corrective actions for mitigating the uplink quality problems as part of the information provided to the operator device.

The platform 320 can also include a classification engine 336 in some examples. The classification engine 336 can be configured to determine whether QoS of a user network session is impacted by uplink quality. In some embodiments, for a user network session whose QoS is determined to be impacted by uplink quality, classification engine functions to determine whether the uplink quality is affected by uplink interference or coverage. In some embodiments, the classification engine 336 functions to perform root cause classification.

In some embodiments, the classification engine 336 is constructed to determine whether QoS of a user network session of a network is impacted by uplink quality by: accessing RAN information for the user network session, generating an actual user experience value for the RAN information by inputting the RAN information into a user-experience model (e.g., generated by the user experience modeling system) for the platform account associated with the network 310; generating nominal RAN information by adjusting feature values of the RAN information that relate to uplink quality so that the adjusted feature values correspond to a nominal uplink quality value for a location associated with the user network session and for cell characteristics (e.g., bandwidth, available control channel elements, etc.) associated with the user network session; generating a nominal user experience value for the nominal RAN information by inputting the nominal RAN information into the user-experience model; comparing the nominal user experience value with the actual user experience value; and determining whether QoS of the user network session is impacted by uplink quality based on the result of the comparison of the nominal user experience value with the actual user experience value. In some embodiments, the platform 320 generates the nominal RAN information based on user-input provided by an operator device. In a first variation, the operator device 181 provides user input that specifies at least one set of nominal feature values. In some embodiments of the first variation, the operator device provides user input that specifies nominal feature values for at least on RAN feature for at least one location and set of cell characteristics. In a second variation, the operator device provides user input that specifies information used by the platform 320 to generate at least one set of nominal feature values. In some embodiments of the second variation, the operator device provides user input that specifies information used by the platform system 105 to generate nominal feature values for at least one RAN feature for at least one location and set of cell characteristics.

The classification engine 336 can be constructed to determine for at least one user network session whose QoS is impacted by uplink quality, whether the session is impacted due to uplink interference or uplink coverage. In an example, the classification engine 336 is constructed to generate a service policy violation alert by aggregating uplink quality problems caused by uplink interference or coverage across cells and time and ordering alerts by the number of impacted users (e.g., mobile network subscribers). In one example, if the classification engine 336 determines that the session is impacted due to uplink interference, the classification engine 336 further performs network interference analysis.

In some embodiments, the user interface system 324 includes a web interface enabled by one or more computing services of the platform 320. In some embodiments, the user interface system 324 enables an administrator or operator of a mobile network 310, 312 to interact with and make requests of the platform 320, view the results of classification engine 336, and more. Additionally, or alternatively, the user interface system 324 may function to deploy an analysis dashboard that may include a timestamp of an event, a root cause of the event, and more.

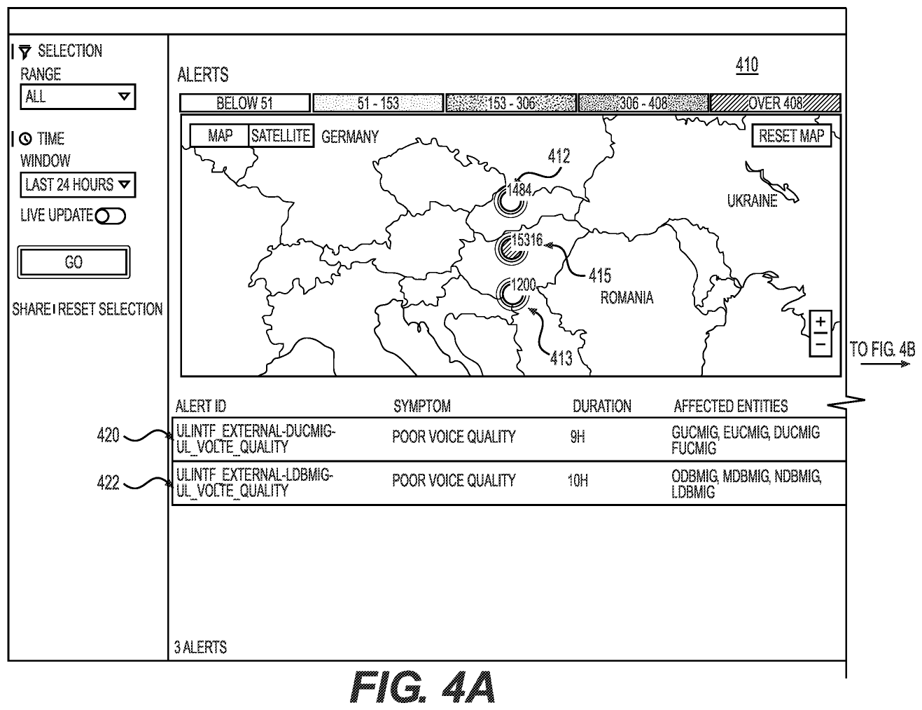

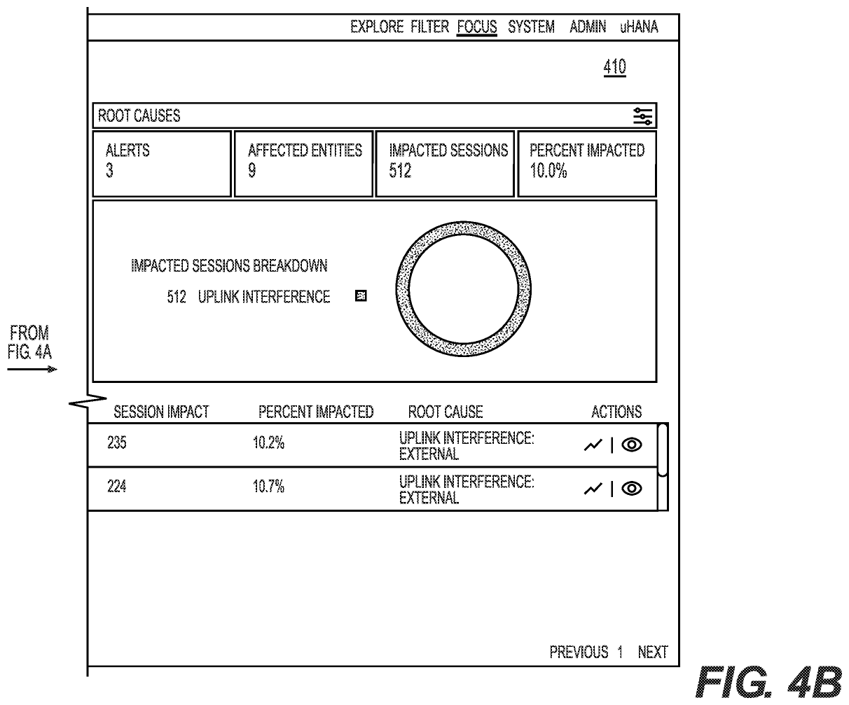

One example of such a dashboard is illustrated in FIGS. 4A-7B. The dashboard can take the form of a GUI dashboard displayed by an operator device 360, 362. In some examples, the GUI dashboard includes information regarding at least one of: timestamps of uplink quality events, unique alert identifiers for the events, an impact on the session for the user device, a start time and end time, a root cause or root causes for the event, and corrective actions for mitigating the interference taken and/or recommended.

FIGS. 4A and 4B are illustrations of an example GUI screen 410 for visualizing uplink quality degradation and root cause information. The screen 410 spans both FIGS. 4A and 4B. Beginning with FIG. 4A, a map area on the screen 410 can show geographic locations of base stations 412, 413, 415. Additionally, numbers of impacted sessions for each base station 412, 413, 415 can be displayed on the GUI. In this example, base station 412 has 1484 impacts, base station 413 has 1200 impacts, and base station 415 has 15316 impacts. These impacts can be limited to a particular type, such as uplink quality degradation, or can include impacts for multiple different performance features, such as load imbalance, voice quality, and downlink throughput. A threshold impact number can be 5000. Because base station 415 exceeds that threshold (having 15316 impacts), it can be highlighted differently on the GUI. This highlighting can indicate that the base station 15316 is a victim cell.

Alerts 420, 422 can be displayed on the GUI relative to one or more selected or displayed cells. In this example, the first alert 420 and second alert 422 both relate to poor voice quality. These can be based on poor coverage impacts being above a threshold number for a period of time. Other alerts are also possible, such as a load imbalance based on poor downlink throughput.

More information can be provided on screen 410 as shown in FIG. 4B. In one example, a root cause is shown for the alerts. For both alerts 420, 422, the root cause can be uplink interference. The administrator can investigate further to determine the source of the interference.

Additionally, screen 410 can give a breakdown of the impacted sessions at the cell. In this example, the sessions are all impacted based on uplink interference. This could be based on the administrator filtering out just the issues related uplink quality degradation or voice quality. However, other issue types can be determined using different performance models and different normalized factors.

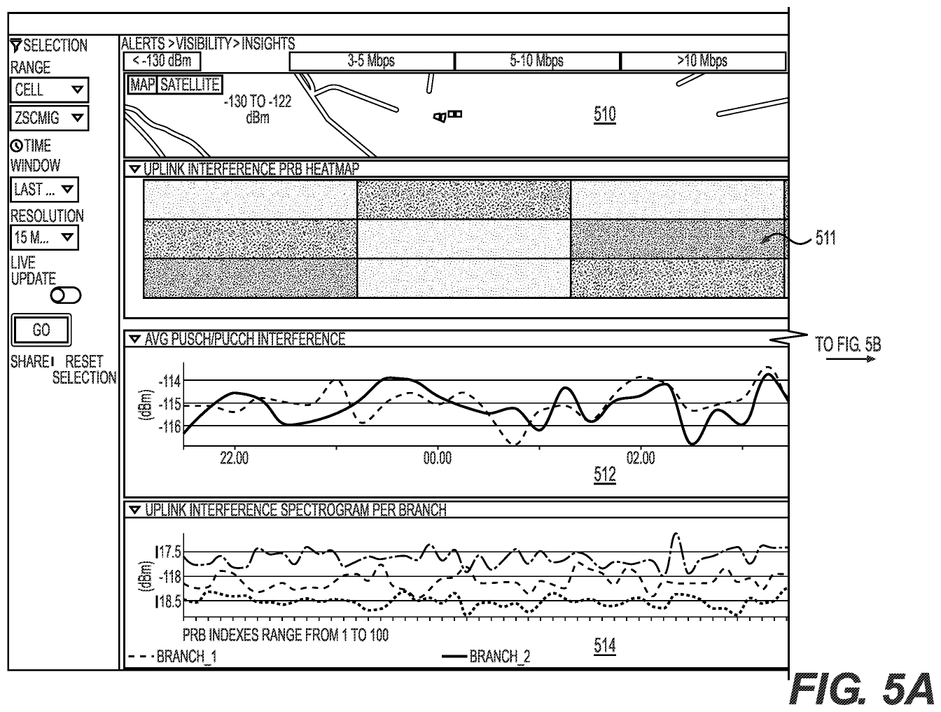

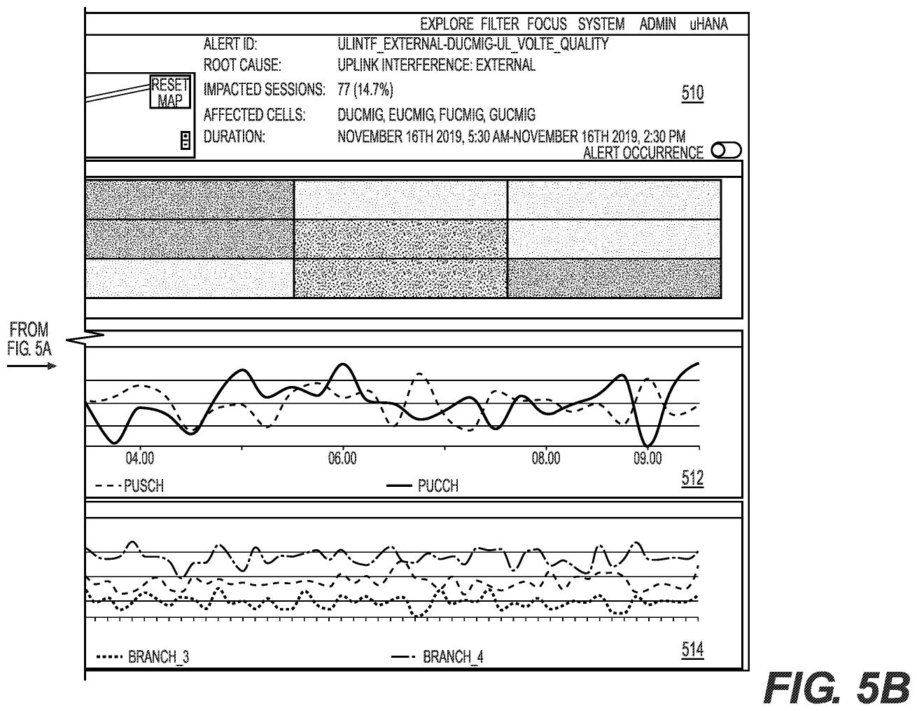

The user can select an alert in one example and see how various factors related to the alert changed during the time span over which the impacts were determined. For example, FIGS. 5A and 5B are illustrations of a second GUI screen 510 for uplink interference details. The second screen 510 can include panes 511, 512, 514 having relevant data regarding the sessions impacted by uplink interference. A first pane 511 graphs uplink interference relative to PRBs. The graph is a heat map showing where the interference was most strongly detected. A second pane 512 is a graph of PUSCH and PUCCH interference levels. A third pane 514 shows an uplink interference spectrogram. These detail screens can allow an administrator to drill down for anomalies related to the impacts.

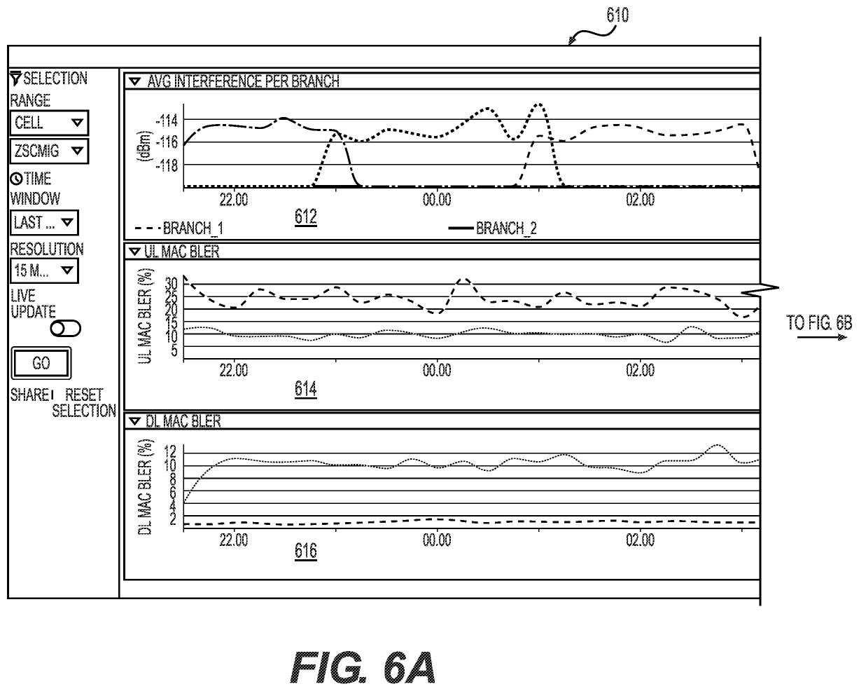

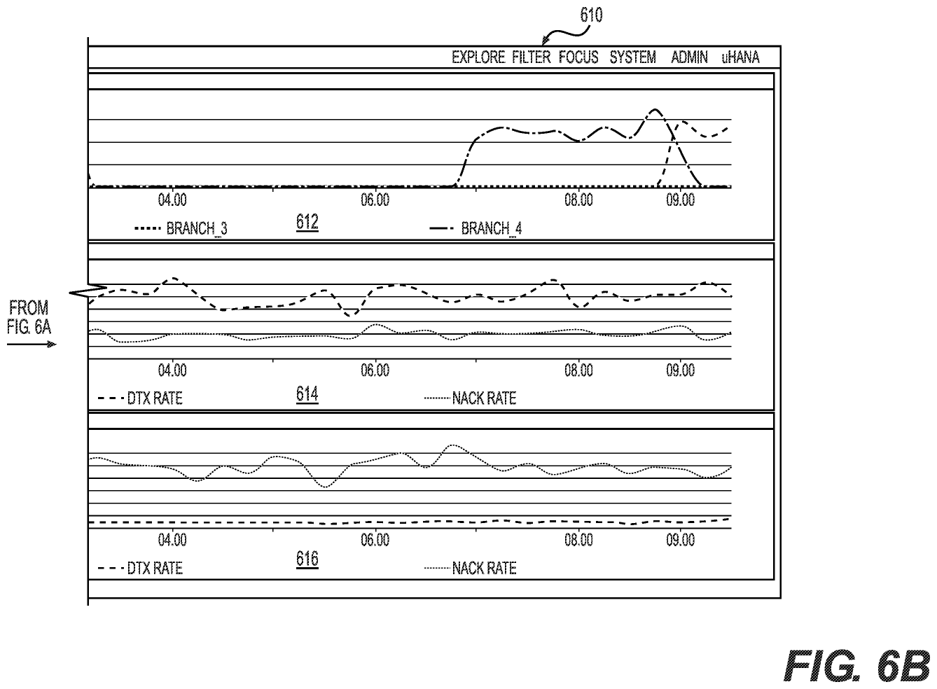

FIGS. 6A and 6B are illustrations of a third example GUI screen 610 showing additional details related to the uplink degradation quality at a cell. Pane 612 includes a graph of interference per branch. Base stations can have multiple different branches (in this case, dual) for transmitting in different protocols, in an example. A second pane 614 includes a graph of block error rate (“BLER”), which can be a ratio of erroneous blocks to total blocks transmitted. The second pane 614 charts BLER with regard to the uplink while the third pane 616 charts BLER for downlink. In both cases, BLER is graphed in terms of NACK rate and DTX rate.

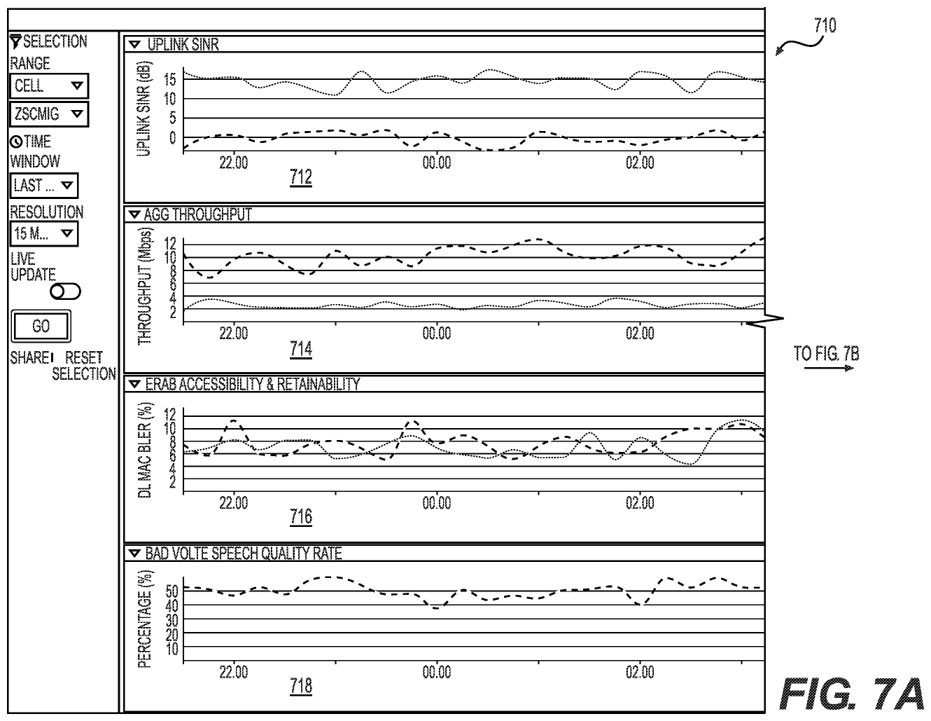

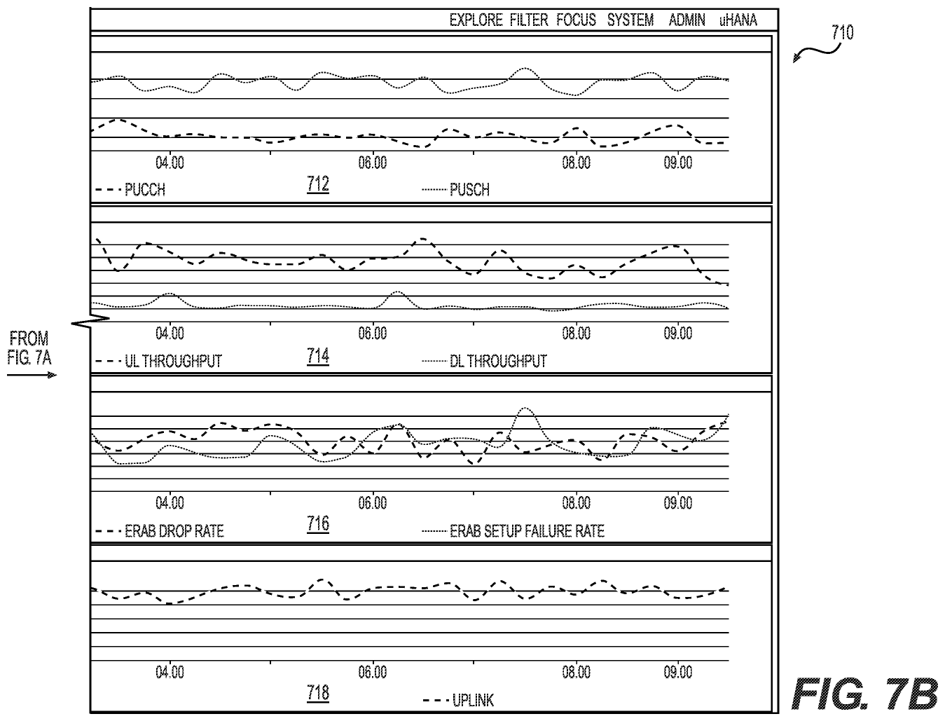

FIGS. 7A and 7B are illustrations of a fourth example GUI screen 710 showing still more details related to the uplink quality degradation. A first pane 712 charts uplink SINR, a second pane 714 charts throughput, a third pane 716 charts downlink BLER, and a fourth pane 718 charts bad speech quality rates.

Other examples of the disclosure will be apparent to those skilled in the art from consideration of the specification and practice of the examples disclosed herein. Though some of the described methods have been presented as a series of steps, it should be appreciated that one or more steps can occur simultaneously, in an overlapping fashion, or in a different order. The order of steps presented are only illustrative of the possibilities and those steps can be executed or performed in any suitable fashion. Moreover, the various features of the examples described here are not mutually exclusive. Rather any feature of any example described here can be incorporated into any other suitable example. It is intended that the specification and examples be considered as exemplary only, with a true scope and spirit of the disclosure being indicated by the following claims.

What is claimed is:

1. A method for detecting uplink quality degradation in a telco network, comprising:
receiving telemetry data;
determining an actual user experience value for a first session at a first base station of a plurality of base stations;
predicting an expected user experience value for the first session based on a normalized uplink quality with respect to the first base station, wherein the normalized uplink quality is based on uplink quality across the plurality of base stations;
classifying the first session as impacted by uplink quality degradation based on the expected user experience value differing from the actual user experience value by at least a threshold amount; and
indicating that uplink quality degradation exists with respect to the first base station.

2. The method of claim 1, wherein the actual and expected user experience values reflect actual and expected downlink throughput values.

3. The method of claim 1, wherein the actual and expected user experience values reflect actual and expected uplink voice quality values.

4. The method of claim 1, wherein uplink quality comprises at least one of uplink interference and uplink coverage.

5. The method of claim 1, wherein the normalized uplink quality is determined based on at least one of: a percentile of the first session's path loss relative to signal quality of other sessions at the first base station, a percentile of discontinuous transmission (DTX) rates across the network, an average channel quality indicator (CQI) over the network, a percentile of control channel signal to noise ratio over the network, and a percentile of data channel signal to noise ratio over the network.

6. The method of claim 1, further comprising isolating the first session based on the first session not being power limited with respect to uplink power.

7. The method of claim 1, further comprising generating an alert for a service policy violation, the alert including an aggregate number of uplink quality problems during a time period, wherein multiple alerts are ordered based on a number of impacted sessions.

8. A non-transitory, computer-readable medium containing instructions that, when executed by a hardware-based processor, performs stages for detecting uplink quality degradation in a telco network, the stages comprising:
receiving telemetry data;
determining an actual user experience value for a first session at a first base station of a plurality of base stations;
predicting an expected user experience value for the first session based on a normalized uplink quality with respect to the first base station, wherein the normalized uplink quality is based on uplink quality across the plurality of base stations;
classifying the first session as impacted by uplink quality degradation based on the expected user experience value differing from the actual user experience value by at least a threshold amount; and
indicating that uplink quality degradation exists with respect to the first base station.

9. The non-transitory, computer-readable medium of claim 8, wherein the actual and expected user experience values reflect actual and expected downlink throughput values.

10. The non-transitory, computer-readable medium of claim 8, wherein the actual and expected user experience values reflect actual and expected uplink voice quality values.

11. The non-transitory, computer-readable medium of claim 8, wherein uplink quality comprises at least one of uplink interference and uplink coverage.

12. The non-transitory, computer-readable medium of claim 8, wherein the normalized uplink quality is determined based on at least one of: a percentile of the first session's path loss relative to signal quality of other sessions at the first base station, a percentile of discontinuous transmission (DTX) rates across the network, an average channel quality indicator (CQI) over the network, a percentile of control channel signal to noise ratio over the network, and a percentile of data channel signal to noise ratio over the network.

13. The non-transitory, computer-readable medium of claim 8, the stages further comprising isolating the first session based on the first session not being power limited with respect to uplink power.

14. The non-transitory, computer-readable medium of claim 8, the stages further comprising generating an alert for a service policy violation, the alert including an aggregate number of uplink quality problems during a time period, wherein multiple alerts are ordered based on a number of impacted sessions.

15. A system for detecting uplink quality degradation in a telco network, comprising:
a memory storage including a non-transitory, computer-readable medium comprising instructions; and
a computing device including a hardware-based processor that executes the instructions to carry out stages comprising:
receiving telemetry data;
determining an actual user experience value for a first session at a first base station of a plurality of base stations;
predicting an expected user experience value for the first session based on a normalized uplink quality with respect to the first base station, wherein the normalized uplink quality is based on uplink quality across the plurality of base stations;
classifying the first session as impacted by uplink quality degradation based on the expected user experience value differing from the actual user experience value by at least a threshold amount; and
indicating that uplink quality degradation exists with respect to the first base station.

16. The system of claim 15, wherein the actual and expected user experience values reflect actual and expected downlink throughput values.

17. The system of claim 15, wherein the actual and expected user experience values reflect actual and expected uplink voice quality values.

18. The system of claim 15, wherein uplink quality comprises at least one of uplink interference and uplink coverage.

19. The system of claim 15, wherein the normalized uplink quality is determined based on at least one of: a percentile of the first session's path loss relative to signal quality of other sessions at the first base station, a percentile of discontinuous transmission (DTX) rates across the network, an average channel quality indicator (CQI) over the network, a percentile of control channel signal to noise ratio over the network, and a percentile of data channel signal to noise ratio over the network.

20. The system of claim 15, the stages further comprising isolating the first session based on the first session not being power limited with respect to uplink power.
